(19) United States
(12) Patent Application Publication
(10) Pub. No.: US 2010/0241545 A1
(43) Pub. Date: Sep. 23, 2010

(54) MASTER FINANCIAL ACCOUNT

(75) Inventors: Sean M. O'Connor, Scituate, MA (US); William F. Borowski, Millbury, MA (US); Kazi M. Ariff, Quincy, MA (US); Carol A. Smith, Edgartown, MA (US); Judith M. Anderson, East Walpole, MA (US); Steven K. Hayes, Bemus Point, NY (US); Thomas D. Kelley, Hingham, MA (US); Neal G. Wolfson, Lexington, MA (US); Susan S. Thomas, Gastonia, NC (US); Russell W. Tipper, Boston, MA (US); Jeffrey P. Judd, Boston, MA (US); William J. Aheron, Charlotte, NC (US); Yicong Li, Lexington, MA (US); Shane A. Johnson, Charlotte, NC (US); James P. Kirkman, Acton, MA (US); Jeffrey H. Bierer, Charlotte, NC (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/407,842

(22) Filed: Mar. 20, 2009

(51) Int. Cl. G06Q 40/00

(52) U.S. Cl. 705/35

(57) ABSTRACT

Apparatus and methods for configuring a master financial account providing comprehensive access to financial services are provided. A master account may be configured for a customer of a financial institution. The master account holder may build a customized array of financial services which may be accessed and managed through the master account. Benefits associated with use of a sub-account may accrue collectively in the master account.

### FIELD OF TECHNOLOGY

Aspects of the disclosure relate to providing services to customers of a financial institution.

### BACKGROUND

Consumers of financial services may maintain separate accounts with different financial institutions. This practice presents a number of disadvantages.

Holding separate accounts adds layers of complexity to account access. Each separate account may require a different account number and personal identification number. Managing the accounts via the Internet may require several different logins and passwords.

Holding separate accounts may also impair efficient financial management. Transfers between accounts with different institutions may require additional procedures. Computerized records from the different accounts may not always be compatible making it difficult to display a single picture of the customer's financial situation.

Holding separate accounts with more than one institution may also limit the relationship between the financial institution and the customer. Without comprehensive information about a customer's financial situation, the institution may not be fully aware of financial needs which it should be addressing. Moreover, the power of customer loyalty rewards is diluted when the customer rewards accrue in the short term with a series of different institutions.

It would be desirable, therefore, to configure a master financial account providing comprehensive access to financial services.

### SUMMARY OF THE INVENTION

It is an object of this invention to provide apparatus and methods for configuring a master financial account providing comprehensive access to financial services. Apparatus and methods for configuring such a master account are therefore provided.

A financial institution able to offer a full range of financial services could efficiently service a customer from a single account. The various financial services could be managed from this master account, enabling streamlined transactions and recordkeeping. Customer loyalty rewards for transactions across all accounts could accrue in the aggregate over the length of a lifetime relationship.

The apparatus and methods may involve configuring a master financial account for a customer of a financial institution. The account may be assigned a master account number and the customer may be assigned a master personal identification number (“PIN”).

Any financial services selected by the customer over the course of a relationship with the financial institution may be configured as sub-accounts accessible via the master account. Each sub-account may be accessible via the same master account number and master Password/Personal Identification Number (PIN) associated with the master account.

The master account may be managed via the Internet. A master login and a master password/PIN may provide access to both the master account and any sub-accounts associated with the master account. Management tasks may include viewing records, transferring funds between sub-accounts or any other suitable tasks.

Customer loyalty rewards for activity within any sub-account may accrue in the aggregate in the master account. In some embodiments, rewards may take the form of a cash reward which may be deposited in one of the sub-accounts.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a schematic diagram of apparatus that may be used in accordance with the principles of the invention; and

FIG. 2 is a flow diagram that shows a process in accordance with the principles of the invention.

### DETAILED DESCRIPTION OF THE INVENTION

Apparatus and methods for configuring a master financial account providing comprehensive access to financial services are provided.

A consumer of financial services may benefit from addressing various financial needs within a master account with a single financial institution. The master account may be customized with an individualized array of financial services. Each service in the array may be configured as a sub-account within the master account. The array of sub-accounts may be modified as the customer's financial needs change.

For example, a customer may open his first account as a master financial account and continue to use that master account to address all of his financial needs over the course of his life. Initially he may need a checking account and a savings account for daily cash use. As his assets accumulate, he may need a brokerage or other investment account. He may purchase a house and need a mortgage. He may have children and choose to set up a college savings account. He may choose to set up a retirement savings account. Each of these new accounts may be configured as sub-accounts of the master account and may be accessed using the account number and personal identification number associated with the master account. The customer may be able to address all his financial needs over the course of a lifetime within a single comprehensive account.

The apparatus and methods may involve configuring a master financial account for a customer of a financial institution. The account may be assigned a master account number and the customer may be assigned a master personal identification number (“PIN”).

To facilitate financial management via the Internet, the customer may be assigned a master account login and a master account PIN/password.

The customer may choose to set up an account for a financial service with the financial institution. Examples of financial services include checking accounts, savings accounts, brokerage accounts, mortgages, credit cards, college savings and retirement savings. The account for the new financial service may be configured as a sub-account of the master account. The sub-account may be associated with the master account number and master PIN.

One or more sub-accounts may be associated with the master financial account to provide the customer with a customized array of financial services. For internal management within the financial institution, the sub-accounts may be designated by separate account numbers, but for the customer, the master account number and PIN may provide comprehensive access to any sub-account in the array.

The master financial account may be managed via the Internet. The master login and master password may provide access to a master software and or hardware shell module which may be linked to each of the array of sub-accounts associated with the master financial account. Management tasks may include transferring funds, making investment choices, viewing records, or any other suitable task. Financial records for any sub-accounts in the array may be displayed individually or in an integrated format. The integrated format may offer a complete picture of the customer's financial situation. Centralized financial records may also simplify calculation of tax liability.

The financial institution may bestow customer loyalty rewards (“rewards”) for various types of activity associated with the institution's financial services. Rewards for activities associated with any of the array of sub-accounts may accrue in the master financial account. Aggregating the rewards earned across the array of sub-accounts enables a customer with several sub-accounts to accumulate significant benefits. Although the array of sub-accounts may change based on the customer's financial needs, the rewards may continue to accumulate in the master financial account independent of the current status of each of the individual sub-accounts. In some embodiments, rewards may be redeemed in the form of cash deposited back into one of the customer's array of sub-accounts. For example, rewards earned for daily cash expenditures from a checking sub-account may be applied toward retirement savings in a different sub-account.

The customer information associated with a sub-account may be used to provide the customer with suggested modifications to the array of sub-accounts associated with the master financial account. For example, information regarding a newborn child may trigger a message to the customer regarding a college savings account. Thus, the comprehensive picture of the customer's financial needs available through the master account enables the institution to serve the customer in a more complete way.

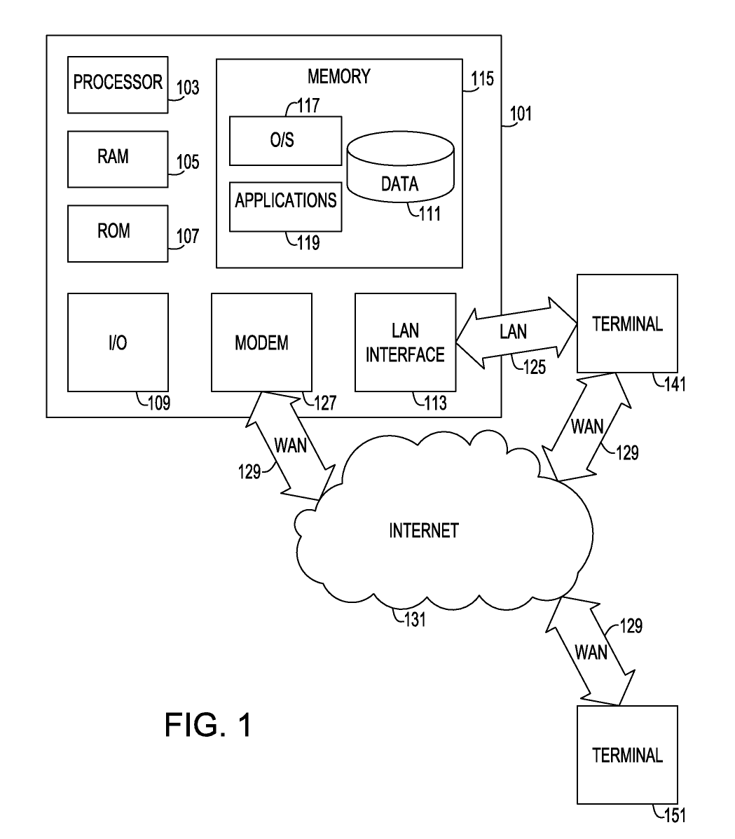

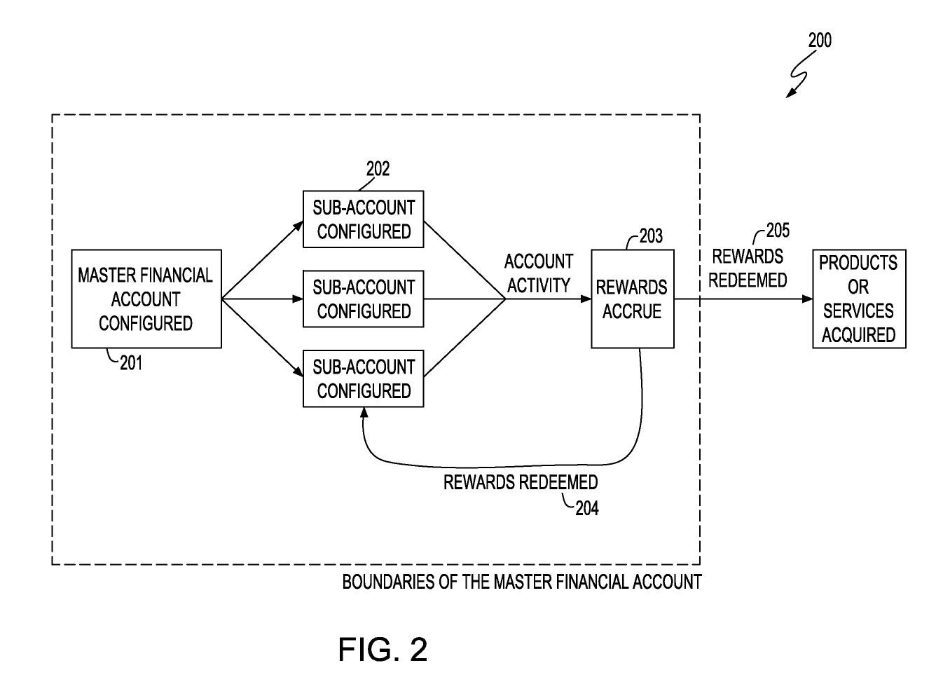

FIGS. 1 and 2 show illustrative embodiments and features of the invention.

In the following description of the various embodiments, reference is made to the accompanying drawings, which form a part hereof, and in which are shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown). As described in detail below, database 121 may provide storage for account information, customer information, and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

FIG. 2 is flow diagram showing illustrative process 200. For the sake of illustration, process 200 will be described as being performed by a system. The system may include one or more of the devices shown in FIG. 1 and/or any other suitable device.

Illustrative process 200 shows an exemplary configuration of the master financial account, the sub-accounts and the reward system. At step 201, a master financial account is configured for the customer. At step 202, various sub-accounts are configured for the customer. The sub-accounts may be considered to be within the master account, and the master account number and the master PIN may be used to access any of these sub-accounts. Sub-accounts may configured at the same time or at different times and may be cancelled or modified according to the customer's needs. At step 203, activity within the sub-accounts may trigger the accrual of rewards. Process 200 may continue at step 204 or step 205 depending on how the rewards are redeemed. At step 204, rewards are redeemed as cash back deposited in a sub-account. At step 205, rewards are redeemed as products or services.

Aspects of the invention have been described in terms of illustrative embodiments thereof. A person having ordinary skill in the art will appreciate that numerous additional embodiments, modifications, and variations may exist that remain within the scope and spirit of the invention.

One of ordinary skill in the art will appreciate that the apparatus features described herein and illustrated in the FIGS. may be arranged in other than the recited configuration and that one or more of the features may be optional. Also, the methods described herein and illustrated in the FIGS. may be performed in other than the recited order and that one or more steps illustrated may be optional. The above-referenced embodiments may involve the use of other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for configuring a master financial account providing comprehensive access to financial services are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for electronically configuring a master financial account, the account providing comprehensive access to financial services, the method comprising:
receiving a request for a master financial account;
associating the master financial account with a master account number;
receiving a selection of a financial service from a master account holder;
configuring a sub-account of the master financial account, the subaccount associated with master account number;
associating the selected financial service with the sub-account of the master financial account.

2. The method of claim 1 wherein the method further comprises associating a master personal identification number with the master account, the personal identification number used to access the master account and the sub-account.

3. The method of claim 1 wherein the method further comprises providing access to the master financial account and the sub-account via an electronic information processing platform, the method comprising configuring a master login associated with the master account and the sub-account.

4. The method of claim 3, the method further comprising configuring a master password associated with the master account and the sub-account.

5. The method of claim 3 wherein the access comprises using the electronic information platform to execute an account management transaction related to the sub-account.

6. The method of claim 3 wherein the access comprises using the electronic information platform to view a record related to the sub-account.

7. A method for establishing an entitlement to a customer benefit, the method comprising:
allocating a first entitlement to a first benefit, the benefit predetermined to correspond to an activity related to a first account;
allocating a second entitlement to a second benefit, the benefit predetermined to correspond to an activity related to a second account;
combining the first and second entitlements; and
receiving a benefit by redeeming at least part of the combined entitlement.

8. The method of claim 7, wherein the benefit comprises at least one of a product and a service.

9. The method of claim 7, wherein the benefit comprises cash to be deposited in a customer account.

10. A method for an electronic determination to extend an offer of a financial service to a customer of a financial institution the method comprising:
storing in machine readable memory at least one of customer personal data related to an existing account and customer financial data related to an existing account;
using a processor, analyzing the customer personal data and customer financial data to assess suitability for a financial service; and
upon receipt of a predetermined trigger within the customer personal data and/or customer financial data, transmitting an offer to the customer.

11. One or more computer-readable media storing computer-executable instructions, which, when executed by a processor on a computer system, perform a method for providing a master account holder with access to financial services, the method comprising:
receiving a selection of a financial service from a master account holder;
configuring a master financial account to provide the master account holder with access to a sub-account;
associating the financial service with the master account, the financial service corresponding to the sub-account; and
storing in machine readable memory data associated with the sub-account.

12. The media of claim 11 wherein, in the method, the financial service comprises at least one of a checking account, saving account, credit card, mortgage, brokerage account, college saving account, and retirement saving account.

13. The media of claim 11, the method further comprising providing access to the master financial account via an electronic information processing platform.

14. The media of claim 13 wherein, in the method, a master login is configured to provide access to the master financial account and the sub-account.

15. The media of claim 13 wherein, in the method, a master password is configured to provide access to the master financial account and the sub-account.

16. The media of claim 11 wherein, in the method, the stored data is used to generate an offer of a financial service to the master account holder.

17. The media of claim 11, the method further comprising, associating a benefit with the master financial account, the benefit accruing based on activity within a sub-account.

18. A system for electronically configuring a master financial account providing access to financial services, the system comprising:
an input module configured to receive a selection of a financial service from a master account holder; and
a processor module configured to create a sub-account associated with the selected financial service, the sub-account access provided via the master financial account.

19. The system of claim 18 wherein the processor module is further configured to:
receive one or both of personal and financial data related to the master account holder; and
store the data in machine readable memory.

20. The system of claim 19, the system further comprising an output module configured to output an offer of a financial service to the master account holder, the offer dependent on the stored data.
